(19) United States
(12) Patent Application Publication
(10) Pub. No.: US 2014/0081677 A1
(43) Pub. Date: Mar. 20, 2014

(54) Self-Service System and Method for Lodging Establishment Convenience Shops

(71) Applicant: NCR CORPORATION, Duluth, GA (US)

(72) Inventors: Jack W. Craig, Ovideo, FL (US); Erick C. Kobres, Lawrenceville, GA (US)

(73) Assignee: NCR CORPORATION, Duluth, GA (US)

(21) Appl. No.: 13/622,772

(22) Filed: Sep. 19, 2012

(51) Int. Cl. G06Q 10/02

(52) U.S. Cl. 705/5

(57) ABSTRACT

A self-service system and method for lodging establishment convenience shops to allow a guest to pay for convenience shop items and avoid waiting in line at a front desk. An example method includes obtaining item identification information associated with items selected for purchase by a customer at a convenience shop of the lodging establishment by a self-service terminal, obtaining prices of the items by the self-service terminal, recording customer selection of a charge to room payment option by the self-service terminal, determining whether the customer has registered as a guest of the lodging establishment by the self-service terminal, and charging a total cost of the items to a reservation record by the self-service terminal when the customer has registered.

### BACKGROUND

The present invention relates to guest management systems in hotels and other lodging establishments, and more specifically to a self-service system and method for lodging establishment convenience shops.

Many lodging establishments offer guests the ability to purchase items such as food, toiletries, and other supplies from pantries, gift shops, and other convenience shops in lobbies. The convenience shops are supervised by front desk employees. Guests who want to purchase items take the items to a front desk to pay for them, which means that the guests may have to wait in line with other guests, for example, guests who are checking in.

Therefore, it would be desirable to provide a self-service system and method for lodging establishment convenience shops to allow a guest to pay for convenience shop items and avoid waiting in line at a front desk.

### SUMMARY

In accordance with the teachings of the present invention, a self-service system and method for lodging establishment convenience shops is provided.

The self-service system and method allow a guest to pay for convenience shop items and avoid waiting in line at a front desk.

An example method includes obtaining item identification information associated with items selected for purchase by a customer at a convenience shop of the lodging establishment by a self-service terminal, obtaining prices of the items by the self-service terminal, recording customer selection of a charge to room payment option by the self-service terminal, determining whether the customer has registered as a guest of the lodging establishment by the self-service terminal, and charging a total cost of the items to a reservation record by the self-service terminal when the customer has registered.

An example method of determining whether the customer has registered as a guest includes obtaining a room number from a room key of the customer, recording customer entry of a verification room number, and comparing the verification room number to the room number obtained from the room key.

Another example method of determining whether the customer has registered as a guest includes obtaining a room number from a reservation barcode of the customer by scanning the reservation barcode from a mobile communication device of the customer, recording customer entry of a verification room number, and comparing the verification room number to the room number obtained from the reservation barcode.

### BRIEF DESCRIPTION OF THE DRAWINGS

FIG. 1 is a block diagram of a lodging management system;

FIG. 2 is an example self-service kiosk for a convenience shop; and

FIG. 3 illustrates an example deployment of the kiosk on a checkout counter;

FIG. 4 illustrates an example deployment of the kiosk within a pedestal;

FIG. 5 is a flow diagram illustrating a self-service convenience shop transaction; and

FIG. 6 is a flow diagram illustrating a charge to room payment process in the self-service convenience shop transaction.

### DETAILED DESCRIPTION

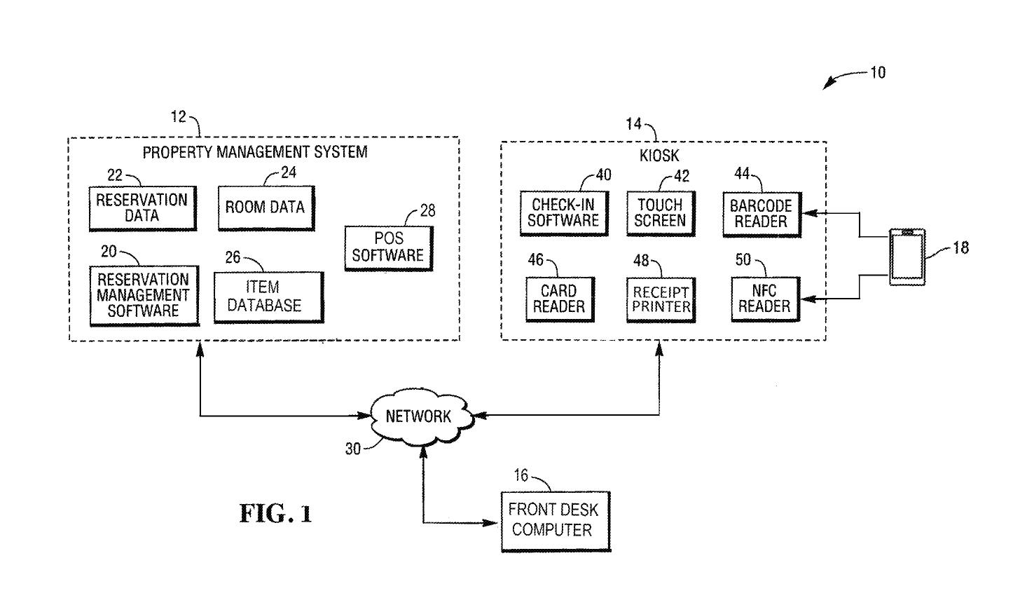

Turning now to FIG. 1, lodging management system 10 primarily includes property management system 12 and convenience shop self-service terminal or kiosk 14.

Property management system 12 manages an inventory of rooms in a lodging establishment as room data 24, including vacant or available rooms and occupied or unavailable rooms. For this purpose, property management system 12 executes reservation management software 20. Reservation management software 20 accepts details of a planned stays, including guest identification information, dates of planned stays, payment information, room assignments, and possibly other information as reservation data 22. Property management system 12 uses the payment information to guarantee the reservation and obtain payment for the duration of the guest's stay at the lodging establishment, including payment for any convenience shop items charged to a guest's room.

Property management system 12 further maintains key data 28 for each room in room data 24.

Property management system 12 may also include an item database 26 containing items for sale at the convenience shop and corresponding prices. Item database 26 may additionally include promotional offers and other information.

Property management system 12 may also include a transaction or point of sale (POS) system 28 which manages most back-end transaction functions. For example, POS system 28 receives barcode information associated with purchased items from kiosk 14 and then returns prices from item database 26 to kiosk 14. As another example, POS system 28 receives credit card data from kiosk 14, processes the credit card data to approve or reject payment, and issues receipt data to the kiosk 14 following approval of payment.

Property management system 12 includes a processor, memory, and program and data storage. Property management system 12 may execute an operating system such as a Microsoft operating system. Property management system 12 may execute other computer software that may be stored in a computer readable medium, such as a memory. Property management system 12 may include one or more computers coupled via a network 30.

Network 30 may include one which uses the TCP/IP protocol. Network 30 may include a combination of local area and wide area networks. Network 30 may include any combination of wireless or wired networks. Network 30 may include a combination of private and public networks, including a global communication network, also known as the Internet.

Kiosk 14 primarily includes a touch screen 42, a barcode reader 44, a card reader 46, an optional receipt printer 48, and near field communications (NFC) reader 50.

Touch screen 42 displays check-out options, information about scanned items, payment information, and records customer selections during a transaction.

Barcode reader 44 reads item identifiers on convenience store items. An example barcode reader 44 may include an imaging barcode reader including a camera or other imaging device. Kiosk 14 may alternatively or additionally include a radio frequency identification (RFID) tag reader.

Card reader 46 may include one or more readers for reads payment cards, loyalty cards, and room keys.

Receipt printer 48 provides a receipt following a transaction.

NFC reader 50 wirelessly receives radio frequency signals containing information sent by a customer's mobile communication device 18, such as a portable digital assistant or smart phone. For example, NFC reader 50 may receive payment information, loyalty information, a confirmation code, and other information.

Kiosk 14 includes a processor, memory, and program and data storage. Kiosk 14 may execute an operating system such as a Microsoft operating system. Kiosk 14 may execute other computer software that may be stored in a computer readable medium, such as a memory.

Kiosk 14 executes transaction software 40. Transaction software 40 displays screens containing information for completing purchases of convenience shop items, processes items for purchase, displays item price information, processes customer selections, and processes payment for the items.

Transaction software 40 may process payment in a plurality of different ways. For example, if a customer elects to pay with a credit card, transaction software 40 displays instructions for completing payment via credit card, and obtains the credit card information from the customer via card reader 46.

Kiosk 14 interfaces with POS system 28 for charging guests who wish to pay via a credit card. Kiosk 14 sends credit card data to POS system 28, which processes the credit card data for approval or rejection, and sends receipt data to kiosk 14 following approval.

As another example, if a customer elects to transfer payment information from a mobile communication device 18, transaction software 40 displays instructions for completing payment, and obtains the payment information from the customer's mobile communication device 18 via NFC reader 50.

As another example, if a customer elects to charge the cost of the items to a room, transaction software 40 displays instructions for charging to a room. The customer may use card reader 46 to read a room key. Transaction software 40 may request entry of verification information, such as entry of the room number using touch screen 42. Transaction software 40 may communicate directly with property management system 12 to verify guest status and obtain payment information.

Alternatively, the customer may elect to place a mobile communication device 18 displaying a reservation barcode adjacent barcode reader 44. Transaction software 40 uses the information in the reservation barcode to obtain the room number assigned to the customer. Transaction software 40 may request entry of verification information, such as entry of the room number using touch screen 42. Transaction software 40 may communicate directly with property management system 12 to verify guest status and obtain payment information.

Kiosk 14 includes a processor, memory, and program and data storage. Kiosk 14 may execute an operating system such as a Microsoft operating system. Kiosk 14 may execute other computer software that may be stored in a computer readable medium, such as a memory.

Kiosk 14 further includes graphics circuitry for connecting to a display portion of touch screen 42, network circuitry for connecting to network 30, and other circuitry for connecting to other peripherals, such as a touch overlay portion of touch screen 42, barcode reader 44, card reader 46, receipt printer 48, and NFC reader 50.

Lodging management system 10 further includes front desk computer 16, which performs check-in functions and optionally other transaction functions. Front desk computer 16 may receive alerts from kiosk 14, such as alerts when payment is not accepted.

Front desk computer 16 includes a processor, memory, and program and data storage. Front desk computer 16 may execute an operating system such as a Microsoft operating system. Front desk computer 16 may execute other computer software that may be stored in a computer readable medium, such as a memory.

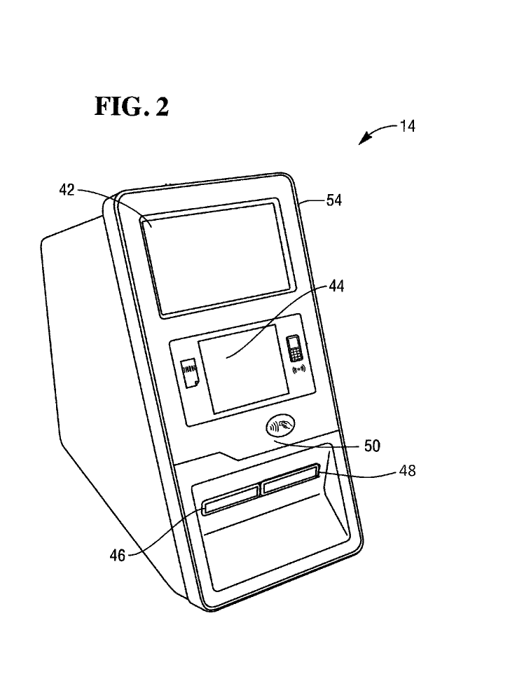

With reference to FIGS. 2-4, an example embodiment of kiosk 14 is illustrated.

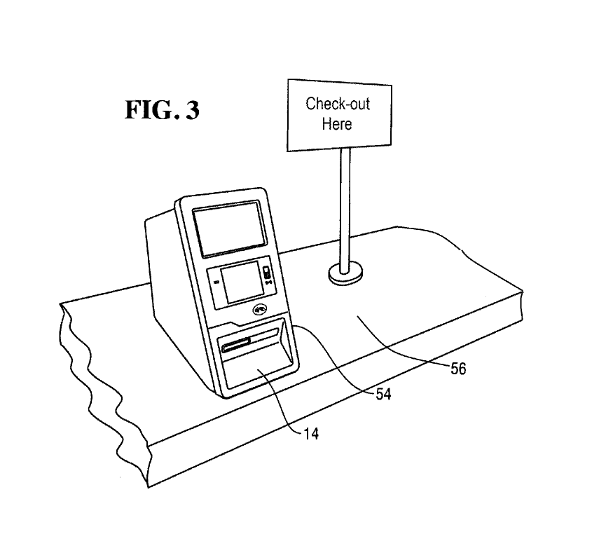

Example kiosk 14 includes a housing 54 which has a small footprint, small enough to sit on a front desk 56 (FIG. 3)

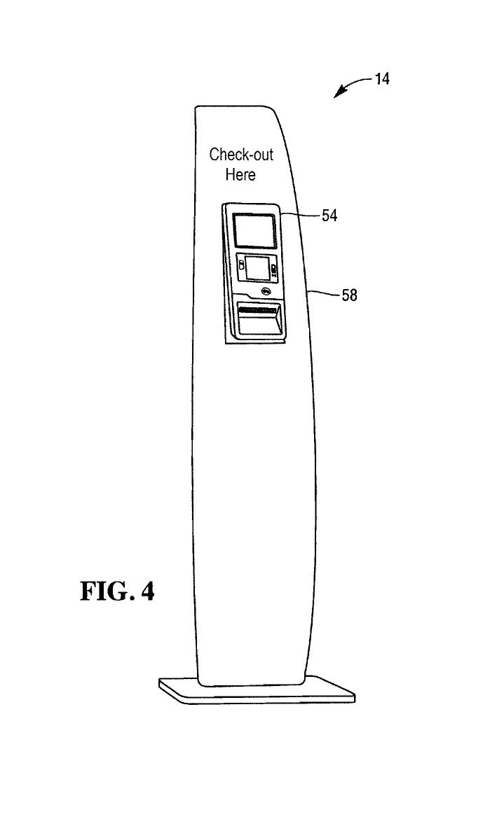

Alternatively, example housing 54 may be incorporated in a free-standing pedestal structure 58 for floor placement within the lodging establishment (FIG. 4).

Touch screen 42 is arranged in an upper portion of the front surface of housing 54, card reader 46 and receipt printer 48 are arranged in a lower portion of the front surface of housing 54, with barcode reader 44 in between and in the front surface of housing 54. Decals or other indicators may be present to assist a guest in proper use of kiosk 14.

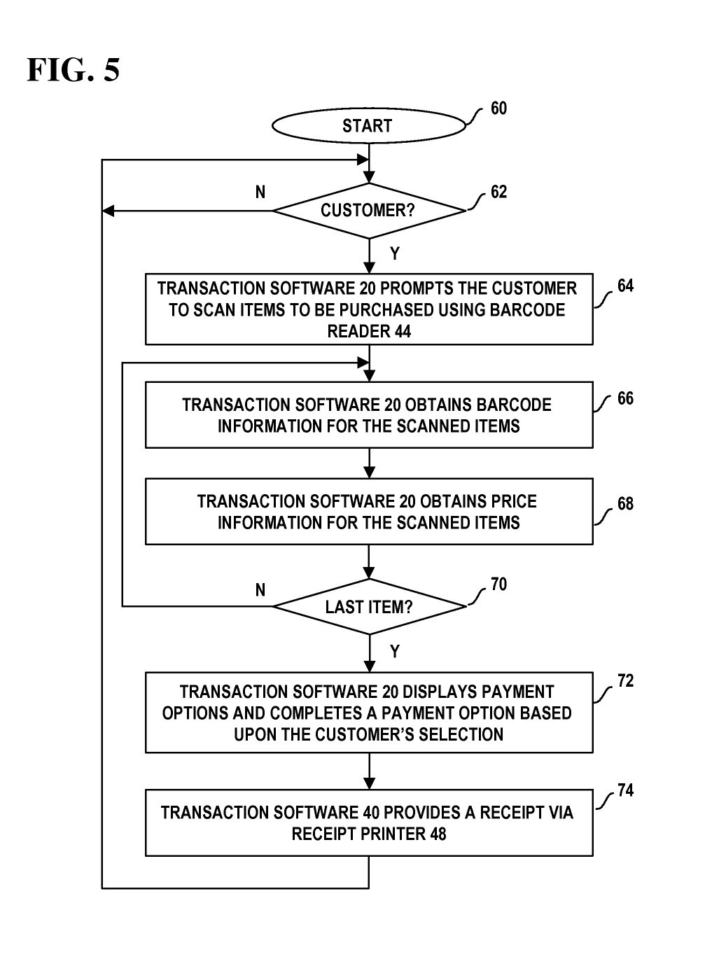

Turning now to FIG. 5, an example convenience shop transaction method is illustrated in detail beginning with Start 60.

In step 62, transaction software 20 displays a start or home screen while waiting for a customer. The home screen may include a prompt such as “touch here to begin a transaction”.

In step 64, transaction software 20 prompts the customer to scan items to be purchased using barcode reader 44.

In step 66, transaction software 20 obtains barcode information for the scanned items.

In step 68, transaction software 20 sends the barcode information to POS system 28 and obtains price information for the scanned items from POS system 28. POS system 28 obtains the price information from item database 26 using the barcode information obtained during scanning. Transaction software 20 may display the price information after each item is scanned.

In step 70, transaction software 20 determines that the customer has finishing scanning the items. For example, the customer may select an option to pay for the items.

In step 72, transaction software 20 displays payment options and completes a payment option based upon the customer's selection. Payment options may include credit or debit card, pay using information in the customer's mobile communication device 18, and charge to room.

If the customer selects payment by credit or debit card, transaction software 40 displays instructions to insert or swipe a credit card in card reader 46 and obtains the card information from the customer via card reader 46. In the case of a debit card, transaction software 40 displays a prompt for the customer to enter a personal identification number (PIN) using touch screen 42.

If the customer selects payment using information from a mobile communication device 18, transaction software 40 displays instructions to place the mobile communication device 18 within range of NFC reader 50, and obtains the payment information from the customer's mobile communication device 18 via NFC reader 50.

If a customer selects charge to room, transaction software 40 displays further options for charge to room payment, which may include room key and reservation barcode.

If the customer selects the room key option, transaction software 40 displays instructions to insert or swipe a room key in card reader 46 and obtains room key information from the customer via card reader 46. Transaction software 40 determines a room number associated with the room key information, displays a prompt for customer entry of verification information, such as a room number, and obtains the entered verification information from touch screen 42.

If the customer selects the reservation barcode option, transaction software 40 displays instructions to scan a reservation barcode displayed by mobile communication device 18 using barcode reader 44 and obtains reservation barcode information from mobile communication device 18 via barcode reader 44. Transaction software 40 determines a room number associated with the reservation barcode information, displays a prompt for customer entry of verification information, such as a room number, and obtains the entered verification information from touch screen 42.

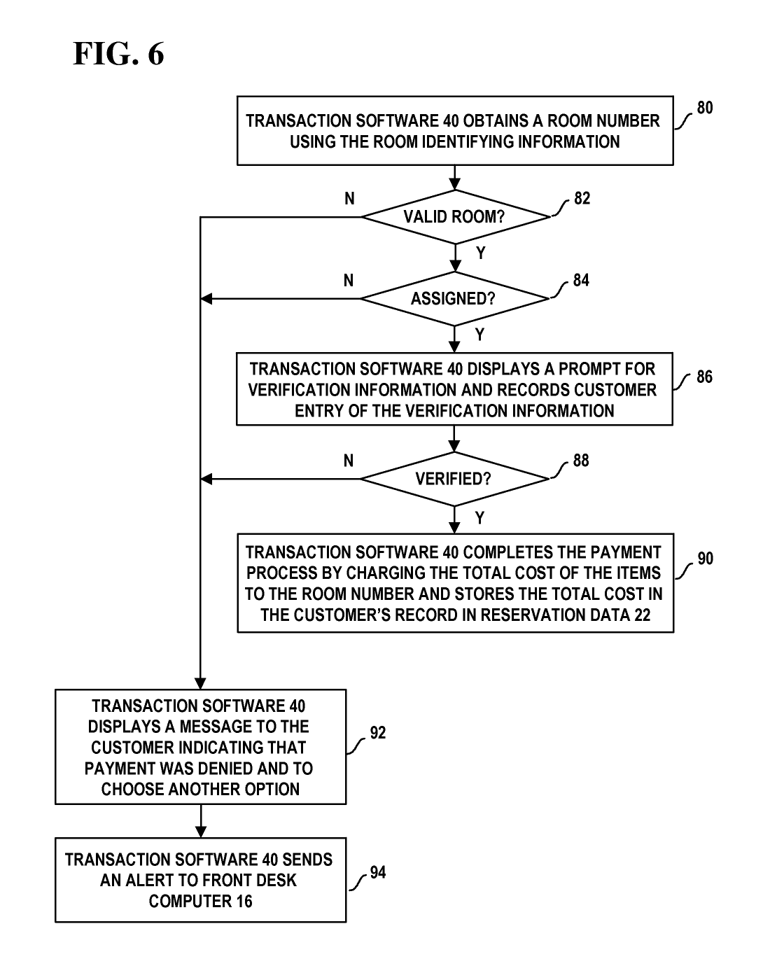

With either charge to room option, case transaction software 40 communicates directly with property management system 12 to verify guest status and obtain payment information from reservation data 22 as illustrated in FIG. 6.

In step 80, transaction software 40 obtains a room number using the room identifying information, where room identifying information includes either the room key information or the reservation barcode information. In the case of room key information, transaction software 40 either obtains the room number directly from the room key information or indirectly from key data 28 using the room key information. In the case of a reservation barcode, transaction software 40 determines the room number associated with the reservation barcode information from reservation data 22.

In step 82, transaction software 40 determines whether the room number corresponds to a room at the lodging establishment from room data 24. If so, operation continues to step 84. Otherwise, operation proceeds to step 92.

In step 84, transaction software 40 determines whether the room is currently assigned to a guest or is currently unassigned. If the room is currently assigned to a guest, operation continues to step 86. Otherwise, operation proceeds to step 92.

In step 86, transaction software 40 displays a prompt for verification information, such as room number, and records customer entry of the verification information.

In step 88, compares the verification information entered by the customer to reservation information associated with the room from reservation data 22. For example, if the verification information is a room number, transaction software 40 compares the room number determined in step 80 to a customer entered room number to verify that the customer is the guest of record for the room determined in step 80. If the customer entered verification information matches information in reservation data 22, operation continues to step 90. Otherwise, operation proceeds to step 92.

In step 90, transaction software 40 completes the payment process and charges the total cost of the items to the room number by storing the total cost in the customer's record in reservation data 22.

If transaction software 40 determines that the room number does not correspond to a room at the lodging establishment, or the room is currently unassigned, or fails to obtain a match between the verification information in reservation data 22 and the verification information entered by the customer, in step 92, transaction software 40 displays a message to the customer indicating that payment was denied and to choose another option.

In step 94, transaction software 40 may additionally alert an attendant at the front desk by sending a message to front desk computer 16 asking the attendant to provide assistance.

Returning to FIG. 5, transaction software 40 provides a receipt via receipt printer 48 in step 74, following acceptance of payment. Operation returns to step 60 to wait for another customer.

Advantageously, customers do not need to stop by the front desk and wait in line to pay for the items.

Although the present invention has been described with particular reference to certain preferred embodiments thereof, variations and modifications of the present invention can be effected within the spirit and scope of the following claims.

What is claimed is:

1. A convenience shop transaction method at a lodging establishment comprising:
obtaining item identification information associated with items selected for purchase by a customer at a convenience shop of the lodging establishment by a self-service terminal;
obtaining prices of the items by the self-service terminal;
recording customer selection of a charge to room payment option by the self-service terminal;
determining whether the customer has registered as a guest of the lodging establishment by the self-service terminal; and
charging a total cost of the items to a reservation record by the self-service terminal when the customer has registered.

2. The method of claim 1, wherein the determining step comprises:
obtaining room key information from a room key of the customer by the self-service terminal.

3. The method of claim 2, wherein the determining step further comprises:
determining whether the room key information corresponds to a room at the lodging establishment by the self-service terminal.

4. The method of claim 3, wherein the determining step further comprises:
determining whether the room is currently assigned or unassigned.

5. The method of claim 4, wherein the determining step further comprises:
recording customer entry of verification information by the self-service terminal; and
comparing the verification information to reservation information associated with the room.

6. The method of claim 1, wherein the determining step comprises:
obtaining a room number from a room key of the customer by the self-service terminal.

7. The method of claim 6, wherein the determining step further comprises:
recording customer entry of a verification room number by the self-service terminal; and
comparing the verification room number to the room number obtained from the room key by the self-service terminal.

8. The method of claim 1, wherein the determining step comprises:
obtaining a room number from a reservation barcode of the customer by the self-service terminal;
recording customer entry of a verification room number by the self-service terminal; and
comparing the verification room number to the room number obtained from the reservation barcode by the self-service terminal.

9. The method of claim 8, wherein the room number obtaining step comprises:
scanning the reservation barcode from a mobile communication device of the customer by the self-service terminal.

10. The method of claim 1, wherein the prices obtaining step comprises:
sending the item identification information to a point of sale system by the self-service terminal; and
obtaining the prices from the point of sale system by the self-service terminal.

11. The method of claim 1, further comprising:
denying payment by the self-service terminal when the customer has not registered.

12. The method of claim 11, further comprising:
sending an alert to a front desk computer asking an attendant to provide assistance to the customer.

13. A lodging establishment convenience shop transaction self-service terminal comprising:
a code reader for obtaining item identification information associated with items selected for purchase by a customer; and
a processor for obtaining prices of the items, for recording customer selection of a charge to room payment option, for determining whether the customer has registered as a guest of the lodging establishment, and for charging a total cost of the items to a reservation record by the self-service terminal when the customer has registered.

14. The self-service terminal of claim 13, wherein the processor obtains a room number from a room key of the customer.

15. The self-service terminal of claim 14, wherein the processor records customer entry of a verification room number, and compares the verification room number to the room number obtained from the room key.

16. The self-service terminal of claim 13, wherein the processor obtains a room number from a reservation barcode of the customer.

17. The self-service terminal of claim 16, wherein the code reader comprises a barcode reader and wherein the barcode reader scans the reservation barcode from a mobile communication device of the customer.

18. The self-service terminal of claim 13, wherein the processor is also for denying payment when the customer has not registered.

19. The self-service terminal of claim 18, wherein the processor is also for sending an alert to a front desk computer asking an attendant to provide assistance to the customer.

20. A lodging establishment convenience shop transaction system comprising:
a property management system for creating a record of a reservation for a guest; and
a convenience shop transaction self-service terminal including
a code reader for obtaining item identification information associated with items selected for purchase by a customer; and
a processor for obtaining prices of the items, for recording selection of a charge to room payment option by the guest, for determining that the guest has the reservation at the lodging establishment, and for charging a total cost of the items to the record of the reservation.
